(19) United States
(12) Patent Application Publication
(10) Pub. No.: US 2022/0046128 A1
(43) Pub. Date: Feb. 10, 2022

(54) METHOD AND SYSTEM FOR REMOTE INTERACTION BETWEEN AT LEAST ONE USER AND A HUMAN OPERATOR AND BETWEEN AT LEAST ONE USER AND AT LEAST ONE AUTOMATED AGENT

(71) Applicant: INVENTIA S.R.L., Milano (IT)

(72) Inventor: Andrea CINELLI, Milano (IT)

(21) Appl. No.: 17/299,017

(22) PCT Filed: Dec. 3, 2019
(86) PCT No.: PCT/IB2019/060399

§ 371 Date: Jun. 2, 2021

(30) Foreign Application Priority Data
Dec. 4, 2018 (IT) 102018000010774

(51) Int. Cl. H04M 3/51; H04L 12/58

(52) U.S. Cl. CPC H04M 3/5166; H04L 51/02; H04M 2203/6054; H04M 2203/6045; H04L 51/10

(57) ABSTRACT

A computer-implemented method is described for remote interaction between a user and an automated agent and for remote interaction between the user and a human operator. The method comprises bidirectionally connecting a user's electronic device with the automated agent by means of a data communication channel through a telecommunications network comprising a server device; acquiring information representative of the identity of a user of the user's electronic device; generating at the server device, as a function of the acquired information representative of the user's identity, a reference profile of digital identity associated with the user of the user's electronic device; storing, into a non-volatile memory of the server device, said user's digital identity reference profile; analysing, by means of an electronic operator device, at least a part of the user's digital identity reference profile.

### BACKGROUND

### Technical Field

The present disclosure generally relates to the field of remote interaction between at least one user and at least one operator of the automated type and of the human type.

### Description of the Related Art

Authentication procedures are well known wherein the identity of a human subject (indicated hereinafter also as “user”) who has been identified in a previous identification step is verified online: in the authentication step it is verified in real time that the user (for example, a user of a smartphone or of a personal computer) who wants to use a particular service is actually the subject he/she has claimed to be in the previous identification step.

The service can be for example the release of a digital certificate associated with the user, the remote subscription of a contract, the opening of a bank account, the activation of a SIM card of a mobile phone, the access to a bank account.

The known procedures for identification and authentication of a subject are mainly carried out in real time, i.e. a user is connected (by means of a local electronic device and through a telecommunications network) to a remote human operator (also provided with an electronic device) and executes an online procedure which requires a real-time interaction between the user and the remote operator.

An example of a guided procedure for remote interaction between at least one user and at least one operator is described in the Italian patent application n. 102017000022073 filed on Feb. 27, 2017 in the name of the same Applicant, which is considered to be incorporated for reference in the present description.

US 2009/0086957 A1 discloses a real-time collaboration centre in which a user 125 interacts with a human operator 130 of a call centre.

US 2009/0086957 A1 further discloses that the user 125 can communicate with an automated agent 150 while waiting for the operator 130 to actually be available to communicate with the user 125; during this waiting time in which the user 125 communicates with the automated agent 150, it is possible to retrieve useful information from the user 125 by means of the communication between the user 125 and the automated agent 150, such as for example upload documents, exchange text messages, carry out voice conversations and/or video.

The Applicant has observed that the known procedures for identification and authentication of the identity of a subject have the following disadvantages:
they require the user to wait for a too long time for the availability of a remote operator, since the operator can be engaged with a similar procedure for verifying the identity of another subject: in this case it is necessary to use a large number of remote operators in order to avoid long waiting times for the users, thus increasing the cost of the system;
the number of procedures which do not conclude correctly the first time is too high, for example due to the incorrect acquisition of documents (for example, insufficient lighting or poor quality of the document to be acquired, the user's photograph of an identity document is too old), thus it is necessary to repeat the complete procedure at least a second time, thus increasing the time during which the human operator is engaged in communications with the user.

Furthermore, the known strong authentication procedures of the identity of a subject are not sufficiently reliable, i.e. do not guarantee with sufficient certainty that the subject to be identified is actually who he/she claims to be.

### BRIEF SUMMARY

One embodiment of the present disclosure relates to a computer-implemented method and a system for remote interaction between at least one user and a human operator and between the at least one user and at least one automated agent as defined in the enclosed independent claims 1 and 9 and from their preferred embodiments described in the dependent claims 2 to 7, 10 and 11-17.

The Applicant has perceived that the remote interaction method and system in accordance with the present disclosure can significantly reduce the time spent waiting for the availability of a remote human operator, maintaining at the same time a reduced number of remote human operators, and also reduces the number of procedures for identification and authentication that do not conclude correctly the first time.

Furthermore the Applicant has perceived that the remote interaction method and system in accordance with the present disclosure can increase the reliability of the strong-type authentication procedures.

One embodiment of the present disclosure is a non-transitory computer-readable storage medium as defined in the enclosed claim 8, said storage medium having a program comprising software code portions adapted to execute the steps of the method according to any of claims 1-7, when said program is run on at least one computer.

One embodiment of the present disclosure a computer program comprising software code portions adapted to perform the steps of the method according to any of claims 1-7, when said program is run on at least one computer.

Said computer program that performs the remote interaction method of claims 1-7 is a software program running partially on a user's electronic device, partially on an automated agent, partially on an electronic operator device and partially on a server device.

### BRIEF DESCRIPTION OF THE SEVERAL VIEWS OF THE DRAWINGS

Additional features and advantages of the disclosure will become more apparent from the description which follows of a preferred embodiment and the variants thereof, provided by way of example with reference to the appended drawings, in which:

FIG. 1 shows a block diagram of an electronic system for remote interaction between a user's electronic device and an electronic operator device and for remote interaction between the user's electronic device and an automated agent according to the disclosure.

### DETAILED DESCRIPTION

It should be observed that in the following description, identical or analogous blocks, components or modules are indicated in the figures with the same numerical references, even where they are illustrated in different embodiments of the disclosure.

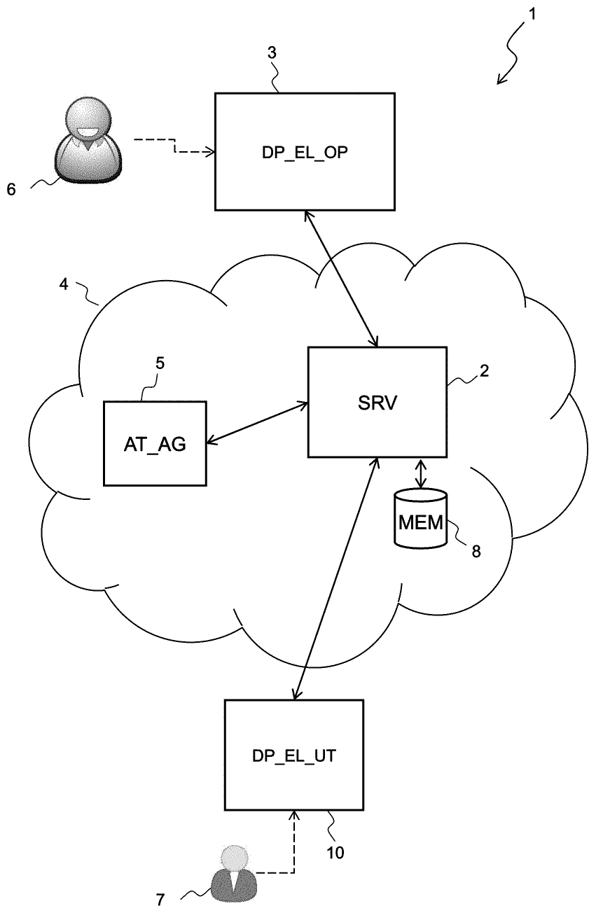

With reference to FIG. 1, it is shown a block diagram of an electronic system 1 for remote interaction between a user's electronic device and an electronic operator device and for remote interaction between the user's electronic device and an automated agent according to the disclosure.

The electronic system for remote interaction 1 comprises:
an electronic operator device 3;
a user's electronic device 10;
a telecommunications network 4 interposed between the electronic operator device 3 and the user's electronic device 10;
a server device 2 positioned in the telecommunications network 4;
an automated agent 5;
a non-volatile memory 8 (for example, a database).

It should be noted that for the sake of simplicity that FIG. 1 shows a single user's electronic device 10 and a single electronic operator device 3, but more generally it is possible to have two or more users' electronic devices and two or more electronic operator devices.

The telecommunications network 4 has the function of bidirectionally connecting the user's electronic device 10 with the electronic operator device 3 and the user's electronic device 10 with the automated agent 5, by means of a data communication channel and by means of the server device 2.

The telecommunications network 4 can be of the fixed type, mobile or a combination of fixed and mobile.

The server device 2 is an electronic device (for example, a computer or a working station) having the function of bidirectionally connecting the user's electronic device 10 with the electronic operator device 3 and bidirectionally connecting the user's electronic device 10 with the automated agent 5.

Furthermore, the server device 2 comprises a processing unit having the function of controlling the execution of the remote interaction processes on the user's electronic device 10, on the electronic operator device 3 and on the automated agent 5, by means of a client-server type architecture.

The electronic system 1 is configured to execute a remote interaction process implemented by means of a plurality of steps (or actions) executed by means of the remote interaction between the user's electronic device 10 and the electronic operator device 3 and by means of the remote interaction between the user's electronic device 10 and the automated agent 5, through the data communication channel and the server device 2.

The term “interaction process” means a procedure comprising a defined sequence of steps (or actions)—i.e. a plurality of predefined steps (or actions)—aimed at delivering a particular good or service for the user 7.

For example, the remote interaction process comprises a procedure for identification and authentication of the identity of the user 7 (in other words, a certification of the identity of the user 7) to deliver one of the following services:
remote release of a digital certificate that is associated with the user 7;
remote subscription of a contract by the user 7 with legal value;
remote opening of a bank account for the user 7;
remote activation of a SIM card of a mobile telephone of the user 7;
access to a bank account held by the user 7 by means of a bank's website.

In particular, the electronic system 1 is configured to execute the remote interaction process of hybrid type according to twophases:
a first automatic phase, wherein the user's electronic device 10 interacts with the automated agent 5 to perform a first plurality of steps (or actions) of the interaction process, in order to collect all the information and documents that do not require the presence of the human operator 6;
a second phase wherein the user's electronic device 10 interacts with the human operator 6 to perform a subsequent second plurality of steps (or actions) of the interaction process, in order to carry out all the steps (or actions) that require a human presence, or in case wherein the presence of human beings is necessary because for example it is required by law or for technical support reasons.

By means of the first phase it is possible to perform all the steps (actions) that do not require the presence of the human operator 6, thus avoiding engaging the operator 6 in automated actions; therefore during the first phase the operator 6 can interact with another user other than the user 10 and thus it is possible to manage for example a high number of video identifications with a lower number of human operators.

For example, the interaction process comprises a verification of the identity of the user 7 (i.e., verification that the user 7 is really who he/she declares to be) and in the first automatic phase information representative of (or associated with) the identity of the user 7 is automatically acquired by means of actions that can be performed in an automatic manner, such as the following:
acquisition of documents of the user 7 (for example, identity card of the user 7);
verification of the acquired documents;
comparison between the photograph of the face of the user 7 of one of his identity documents and the real-time image of the face of the user acquired by means of a camera of the user's electronic device 10, by means of the combination of algorithms of machine learning and biometrics;
verification that the user 7 is a living person (and not an image on a photograph), by means of a biometric facial recognition of the user 7.

Furthermore, in the first phase it is possible to execute the same automated action more than once, in the case wherein a step (action) of the remote interaction procedure between the user 7 and the automated agent 5 has not been executed correctly.

For example, the remote interaction procedure comprises the remote certification of the identity of a subject and the step (action) executed in the first phase is the presentation of a document (such as an identity card) of the subject in front of a camera that it is supposed to occur in insufficient lighting conditions: in this case the automated agent 5 verifies that the quality of the acquired image of the document is inadequate and it does not proceed to the subsequent step (action) of the certification procedure of the identity of the user 7, but the automated agent 5 asks the user 7 to repeat the display of his identity document in front of the camera of the user's electronic device 10 in better lighting conditions.

Therefore in the first phase the automatic verifications are executed to determine whether it is or is not possible to continue with the next step (action) of the remote interaction procedure.

In the second phase, instead, the remaining steps (or actions) of the remote interaction process that require the presence of a human are executed, wherein said steps of the second phase can be one or more than one.

For example, the remote interaction procedure comprises the certification of the identity of a subject and in the second phase, the necessary steps (actions) are executed to validate the identity of the user 7, such as for example:
control and approval of the entire documentation associated with the user 7 which has been acquired in the first automated phase;
“de visu” verification of the identity document;
“de visu” recognition of the user 7;
technical support.

Therefore in the example of certification of the identity of a subject, in the second phase the human operator 8 receives the documents already verified in an optimum manner by means of the automated agent 5 and thus the operator 8 has only to check the documents in a few seconds and execute a real time video connection with the user 7.

The electronic operator device 3 is controlled by a human operator 6 and it is configured to run a software program (hereinafter indicated as “operator software application”) that allows interacting with the user's electronic device 10, in order to execute the second phase of the remote interaction process between the user's electronic device 10 and the electronic operator device 3.

The electronic operator device 3 comprises a processing unit, a transceiver, a graphic user interface (for example, an LCD or LED screen), a camera and a headset.

The electronic operator device 3 can be for example one of the following devices:
a desktop personal computer;
a laptop personal computer;
a smartphone;
a tablet.

Similarly, the user's electronic device 10 is controlled by a user 7 and it is configured to run a software program that allows to:
interact with the automated agent 5 through the data communication channel, in order to execute the first phase of the remote interaction process;
interact with the electronic operator device 3 through the data communication channel, in order to execute the second phase of the remote interaction process.

The user's electronic device 10 is configured to exchange text messages with the automated agent 5 in the first phase and with the electronic operator device 3 in the second phase by means of respective chats, wherein the text messages are carried through the telecommunications network 4 and server device 2.

Alternatively or in combination with the chat, the user's electronic device 10 is configured to exchange audio messages with the automated agent 5 in the first phase and with the electronic operator device 3 in the second phase by means of respective audio chats, wherein the text and/or audio messages are carried through the telecommunications network 4 and the server device 2.

Alternatively or in combination with the chat, the user's electronic device 10 is configured to exchange audio-video messages with the automated agent 5 in the first phase and with the electronic operator device 3 in the second phase by means of respective audio-video chats, wherein the text and/or audio-video messages are carried through the telecommunications network 4 and the server device 2.

The user's electronic device 10 comprises a processing unit, a transceiver, a graphic user interface (for example, an LCD or LED screen), a camera and a headset.

The user's electronic device 10 can be for example one of the following devices:
a desktop personal computer;
a laptop personal computer;
a smartphone;
a tablet.

The automated agent 5 is a software program running on the server 2 and it has the function of interacting with the user's electronic device 10 of the user 7, in order to execute the first automated step of the remote interaction process.

The automated agent 5 is configured to execute all the steps of the remote interaction process that can be performed in an automatic manner, i.e. without requiring the intervention of the human operator 6, as described above.

In one embodiment, the software program that implements the automated agent 5 runs artificial intelligence algorithms that are able to emulate the behaviour of a human being.

According to a preferred embodiment, the processing unit of the server device 2 is configured to calculate a digital identity reference profile associated with the user 7, as a function of the personal and/or biometric information of the user 10 collected during the first automated phase of the remote interaction process.

The term “identify reference profile” of the user means a collection of personal information identifying the user 7, such as for example an encoded text file that comprises one or more of the following:
name and surname;
date and place of birth;
residence address;
fiscal code;
telephone number;
email address;
biometric parameters of the face of the user 7, such as for example the interpupillary distance, distances between particular points of the face (nose, the outline of the face, outline of the eyebrows).

In this case the memory 8 is configured to permanently store the digital identity reference profile of the user 10.

In other words, at the end of the first automatic phase the digital identity reference profile of the user 10 is calculated, which can advantageously be used subsequently, both in the second phase of the remote interaction process, and in the case of procedures for verifying the identity of the user 7 using a strong authentication, and for other applications outside of the interaction process considered.

In one embodiment, the biometric parameters of the digital identity reference profile are generated by means of the acquisition of a plurality of biometric parameters of the face of the subject 7 obtained by means of the movement of the head of the subject 7, as disclosed in the Italian patent application n. 102017000145528 filed on Dec. 18, 2017 in the name of the same Applicant, which is included for reference in the present description.

In particular, the digital identity reference profile is of an anonymous type.

For example, the remote interaction process comprises a verification and authentication procedure of the identity of the user 7: in this case in the first automated step (by means of the communication between the user's electronic device 7 and the automated agent 5 through the network 4 and the server 2) the personal information of the user 7 is acquired, such as name, surname, date and place of birth, residence address, fiscal code and a photograph.

The processing unit of the server device 2 processes the personal information acquired from the user 7 and generates, as a function therefrom, an anonymous hash code, i.e. by means of a suitable function a pseudo-random code is generated that provides in output the same result in the case of a same input.

According to a preferred embodiment, the digital identity reference profile of the user 10 is stored into a blockchain.

According to a first variant of the disclosure, the digital identity reference profile of the user 10 (calculated at the end of the first phase and stored permanently into the memory 8) is used to increase the security level in the procedures for verifying the identity of the user 7 in the case of use of a strong authentication, i.e. which use a combination of at least two authentication factors of a different type to increase the security level with which the subject is identified.

Therefore in case wherein the user 7 requests a good or service in telematics mode, it is possible to reuse the digital identity reference profile of the user 10 previously calculated and stored into the memory 8. In this case the user 10 carries out for the second time an identity verification procedure by means of the collection of personal and/or biometric-type data and a new digital identity profile of the user 7 is calculated in real time (hereinafter indicated as “sample profile of digital identity”, to distinguish it from the digital identity reference profile), which is compared (before or after another authentication factor) with repect to the digital identity reference profile stored into the memory 8:

in case wherein the comparison between the sample profile of digital identity of the user 7 (calculated in real time) and the digital identity reference profile of the user 7 (previously stored) is positive, this means that the authentication factor has been positive and thus it continues with the comparison of the other authentication factor (if subsequent to that of the digital identity profile) or the verification of the identity of the user 7 concludes successfully (in case wherein the factor of the digital identity profile is the last);

in case wherein the comparison between the sample profile of digital identity (calculated in real time) and the reference identity profile (previously stored) is negative, this means that the authentication of the user 7 has not been successful (i.e. the user 7 is not really who declares to be) and thus the verification of the identity of the user 7 terminates unsuccessfully.

For example, the digital identity reference profile (previously stored) is used to allow or deny access to the user 7 to a bank account, in case wherein it is used a strong authentication composed of a verification of the credentials of the user 7 followed by the verification of the digital identity profile of the user 7.

In this example the user 7 opens the bank's web page with a browser, enters his credentials with a positive outcome and then it is executed (by means of the processing unit in the server device 2) the comparison between the sample profile of digital identity of the user 7 (calculated in real time) and the digital identity reference profile of the user 7 (previously stored), in order to allow or deny the user 7 access to the requested bank account.

The above considerations relating to the digital identity reference profile of the user 7 are applicable in a similar way to the sample profile of digital identity of the user 7, i.e. the term “sample profile of identity” of the user means a collection of personal information identifying the user 7, such as for example one or more of the following:
name and surname;
date and place of birth;
residence address;
fiscal code;
telephone number;
email address;
biometric parameters of the face of the user 7, such as for example the interpupillary distance, distances between particular points of the face (nose, the outline of the face, outline of the eyebrows).

In one embodiment, the biometric parameters of the sample profile of digital identity are generated by means of the acquisition of a plurality of biometric parameters of the face of the subject 7 obtained by means of the movement of the head of the subject 7, as disclosed in the Italian patent application n. 102017000145528 filed on Dec. 18, 2017 in the name of the same Applicant, which is included for reference in the present description.

According to a second variant of the disclosure, the digital identity reference profile of the user 10 (calculated at the end of the first phase and permanently stored into the memory 8) is used for access to third-party applications that require an acquisition of data identifying the identity of the user 10, for example by banks, telephone companies and insurance companies.

Therefore in the case in which the user 7 tries to log on for the first time to a software application by means of the user's electronic device 10 (after the user 7 has already carried out the remote interaction process a first time in order to generate his digital identity reference profile as illustrated above, in particular only the first automated phase), it is possible to reuse the digital identity reference profile of the user 7 (previously calculated and stored into the memory 8) to quickly provide data identifying the identity of the user 7 (i.e. sensitive and/or biometric data of the user 7) without again requesting the insertion of all his data (for example by means of a simple “click” with the mouse), thus creating a “digital passport” of the user 7.

1. Computer-implemented method for remote interaction between a user and an automated agent and for remote interaction between the user and a human operator, the method comprising:
a) bidirectionally connecting a user's electronic device to the automated agent by means of a data communication channel through a telecommunications network comprising a server device;
b) configuring in real time the user's electronic device to execute a step of an interaction process, wherein the interaction process is partially implemented by means of a first plurality of steps executed by means of the interaction between the user's electronic device and the automated agent through the data communication channel of the telecommunications network;
c) configuring in real time the automated agent to execute said step of the interaction process;
d) executing said step of the first plurality by means of exchanging, between the user's electronic device and the automated agent, text messages of an online chat and/or by means of exchanging audio/audio-video messages of an audio/audio-video online chat, wherein said text and/or audio/audio-video messages are carried through said telecommunications network, said step comprising acquiring information representative of the identity of a user of the user's electronic device;
e) verifying, by means of the automated agent, whether the step of the first plurality has been executed correctly by means of the user's electronic device;
f) in case of positive verification, approving by means of the automated agent the step of the first plurality and repeating c), d), e), f) for a further step of the first plurality of steps;
g) in case of negative verification, repeating the execution of the step of the first plurality of steps of the interaction process and returning to e), till completing the execution of the first plurality of steps with positive verifications;
h) generating at the server device, as a function of the acquired information representative of the user's identity, a reference profile of digital identity associated with the user of the user's electronic device;
i) storing, into a non-volatile memory of the server device, said user's digital identity reference profile;
j) bidirectionally connecting the user's electronic device to an electronic operator device by means of a data communication channel through the telecommunications network;
k) configuring in real time the user's electronic device to execute a step of the interaction process, wherein the interaction process is further implemented by means of a second plurality of steps subsequent to the first plurality of steps and executed by means of the interaction between the user's electronic device and the electronic operator device through the data communication channel;
l) configuring in real time the electronic operator device to execute said step of the interaction process;
m) executing said step of the second plurality by means of exchanging, between the user's electronic device and the electronic operator device, of text messages of an online chat and/or by means of exchanging audio/audio-video messages of an audio/audio-video online chat, wherein the text and/or audio/audio-video messages are carried through said telecommunications network;
n) analyzing, by means of the electronic operator device, at least a part of the user's digital identity reference profile;
o) in case of a positive analysis, approving by means of the electronic operator device the step of the second plurality and repeating l), m), n), o) for a further step of the second plurality of steps;
p) in case of a negative analysis, repeating the execution of the step of the second plurality of steps of the interaction process and returning to n), till completing the execution of the second plurality of steps with positive verifications.

2. Method for remote interaction according to claim 1, wherein the digital identity reference profile is a set of personal information identifying the user, in particular comprising name and surname, date and place of birth, residence address, fiscal code, telephone number, email address, biometric parameters of the face of the user,
and wherein h) comprises generating the user's digital identity reference profile comprising an encoded text file of anonymous type.

3. Method for remote interaction according to claim 2, wherein the digital identity reference profile is a hash code.

4. Method for remote interaction according to claim 1, comprising a procedure for verifying the identity of the user by means of a strong authentication comprising at least two factors, wherein one of the two factors comprises a further interaction process between the user's electronic device and the electronic operator device and/or the automated agent, the method comprising:
a1) executing said step of the further interaction process by means of exchanging, between the user's electronic device and the electronic operator device and/or the automated agent, of text messages of an online chat and/or by means of exchanging audio/audio-video messages of an audio/audio-video online chat, wherein the text and/or audio/audio-video messages are carried through said telecommunications network, said step comprising acquiring information representative of the identity of the user of the user's electronic device;
b1) generating at the server device, as a function of the acquired information representative of the user's identity, a sample profile of digital identity associated with the user of the user's electronic device;
c1) comparing the sample profile of digital identity associated with the user with respect to the digital identity reference profile;
d1) in case of a negative comparison, generating a message representative of a negative verification of the user's identity of the user's electronic device;
d2) in case of a positive comparison, generating a message representative of a positive verification of the user's identity of the user's electronic device.

5. Method for remote interaction according to claim 1, wherein the interaction process is a procedure for identification and authentication of the user's identity,
wherein the first plurality of steps comprises at least one of the following steps:
acquiring an identity document of the user;
comparing a photo of the face of the user of his identity document with respect to a real time image of the user's face acquired by means of a camera of the user's electronic device;
biometric recognition of the user's face by means of a plurality of acquired images of the user's face, in order to verify whether the user is a living person.

6. Method for remote interaction according to claim 1, wherein the interaction process of the first and second plurality of steps is one of the following:
procedure for identification and authentication of the identity of the remote user for the release of a digital certificate associated with the remote user;
procedure for identification and authentication of the identity of the remote user for the remote subscription of a contract for the remote user;
procedure for identification and authentication of the identity of the remote user for performing a remote opening of a bank account for the remote user;
procedure for identification and authentication of the identity of the remote user for performing the remote activation of a SIM card of a user's smartphone;
procedure for identification and authentication of the identity of the remote user for performing the access to a user's bank account by means of a bank's website.

7. Method for remote interaction according to claim 1, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
l1) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.

8. Non-transitory computer-readable storage medium, said storage medium comprising software code portions adapted to perform the steps of the method according to claim 1, when said program is run on a computer.

9. Electronic system for remote interaction between a user an automated agent and for remote interaction between the user and a human operator, the system comprising:
a user's electronic device controlled by a remote user;
an electronic operator device controlled by an operator;
an automated agent;
a telecommunications network configured to bidirectionally connect the user's electronic device to the electronic operator device by means of a data communication channel;
a server device within the telecommunications network;
a non-volatile memory configured to store a digital identity reference profile associated with the user of the user's electronic device;
wherein the user's electronic device is configured to:
configure itself in real time to execute a step of an interaction process, wherein the interaction process is partially implemented by means of a first plurality of steps executed by means of the interaction between the user's electronic device and the automated agent through the data communication channel;
execute said step of the first plurality by means of exchanging with the automated agent of text messages of an online chat and/or by means of exchanging audio/audio-video messages of an audio/audio-video online chat, wherein said text and/or audio/audio-video messages are carried through said telecommunications network, said step comprising acquiring information representative of the identity of the user of the user's electronic device;
in case of positive verification of the correct execution of the step of the first plurality of steps, repeat said configuration, execution, verification for a further step of the first plurality of steps;
in case of negative verification of the correct execution of the step of the first plurality of steps, repeat said execution of the step of the first plurality and said verification, till completing the execution of the first plurality of steps with positive verifications;
configure itself in real time to execute a step of an interaction process, wherein the interaction process is further implemented by means of a second plurality of steps subsequent to the first plurality of steps and executed by means of the interaction between the user's electronic device and the electronic operator device through the data communication channel;
execute said step of the second plurality by means of exchanging with the electronic operator device of text messages of an online chat and/or by means of exchanging audio/audio-video messages of an audio/audio-video online chat, wherein the text and/or audio/audio-video messages are carried through said telecommunications network;
in case of a positive analysis of at least part of the user's digital identity reference profile, repeat said configuration, execution of the step of the second plurality and analysis for a further step of the second plurality of steps;
in case of a negative analysis, repeat the execution of the step of the second plurality of steps of the interaction process and said analysis of a part of the user's digital identity reference profile, till completing the execution of the second plurality of steps with positive verifications;
wherein the automated agent is configured to:
configure itself in real time to execute the first plurality of steps;
verify whether the step of the first plurality has been executed correctly by means of the user's electronic device;
in case of positive verification, approve the step of the first plurality of steps and repeat said configuration, execution of the step of the first plurality and verification for a further step of the first plurality of steps;
wherein the electronic operator device is configured to:
configure itself in real time to execute the second plurality of steps;
execute said step of the second plurality by means of exchanging text messages of an online chat and/or by means of exchanging audio/audio-video messages of an audio/audio-video online chat, wherein the text and/or audio/audio-video messages are carried through said telecommunications network;
analyze at least a part of the user's digital identity reference profile;
in case of a positive analysis, approve by means of the electronic operator device the step of the second plurality and repeat said configuration, execution of the step of the second plurality and analysis for a further step of the second plurality of steps;
in case of a negative analysis, repeat the execution of the step of the second plurality of steps of the interaction process and repeat said analysis, till completing the execution of the second plurality of steps with positive verifications;
and wherein the server device is configured to:
generate, as a function of the acquired information representative of the user's identity, a reference profile of digital identity associated with the user of the user's electronic device;
store, in the memory, said user's digital identity reference profile;
and wherein the memory is configured to store said user's digital identity reference profile.

10. Electronic system according to claim 9, comprising a further user's electronic device of a further user,
wherein the electronic operator device is configured to exchange, with the further user's electronic device, text messages of an online chat and/or audio/audio-video messages of an audio/audio-video online chat, during at least a part of the time interval in which the user's electronic device is configured to exchange, with the automated agent, text messages of an online chat and/or audio/audio-video messages of an audio/audio-video online chat.

11. Method for remote interaction according to claim 2, comprising a procedure for verifying the identity of the user by means of a strong authentication comprising at least two factors, wherein one of the two factors comprises a further interaction process between the user's electronic device and the electronic operator device and/or the automated agent, the method comprising:
a1) executing said step of the further interaction process by means of exchanging, between the user's electronic device and the electronic operator device and/or the automated agent, of text messages of an online chat and/or by means of exchanging audio/audio-video messages of an audio/audio-video online chat, wherein the text and/or audio/audio-video messages are carried through said telecommunications network, said step comprising acquiring information representative of the identity of the user of the user's electronic device;
b1) generating at the server device, as a function of the acquired information representative of the user's identity, a sample profile of digital identity associated with the user of the user's electronic device;
c1) comparing the sample profile of digital identity associated with the user with respect to the digital identity reference profile;
d1) in case of a negative comparison, generating a message representative of a negative verification of the user's identity of the user's electronic device;
d2) in case of a positive comparison, generating a message representative of a positive verification of the user's identity of the user's electronic device.

12. Method for remote interaction according to claim 3, comprising a procedure for verifying the identity of the user by means of a strong authentication comprising at least two factors, wherein one of the two factors comprises a further interaction process between the user's electronic device and the electronic operator device and/or the automated agent, the method comprising:
a1) executing said step of the further interaction process by means of exchanging, between the user's electronic device and the electronic operator device and/or the automated agent, of text messages of an online chat and/or by means of exchanging audio/audio-video messages of an audio/audio-video online chat, wherein the text and/or audio/audio-video messages are carried through said telecommunications network, said step comprising acquiring information representative of the identity of the user of the user's electronic device;
b1) generating at the server device, as a function of the acquired information representative of the user's identity, a sample profile of digital identity associated with the user of the user's electronic device;
c1) comparing the sample profile of digital identity associated with the user with respect to the digital identity reference profile;
d1) in case of a negative comparison, generating a message representative of a negative verification of the user's identity of the user's electronic device;
d2) in case of a positive comparison, generating a message representative of a positive verification of the user's identity of the user's electronic device.

13. Method for remote interaction according to claim 2, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
l1) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.

14. Method for remote interaction according to claim 3, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
1l) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.

15. Method for remote interaction according to claim 4, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
l1) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.

16. Method for remote interaction according to claim 11, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
l1) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.

17. Method for remote interaction according to claim 12, further comprising:
k1) configuring in real time a further user's electronic device to execute a step of a further interaction process during at least a part of the time interval in which the user's electronic device is configured to exchange, with the automated agent, text messages of an online chat and/or audio/audio-video messages of an audio/audio-video online chat, wherein the further interaction process is implemented by means of a further plurality of steps executed by means of the interaction between the user's electronic device and the electronic operator device through the data communication channel;
l1) configuring in real time the electronic operator device to execute said step of the further interaction process;
m1) executing said step of the further plurality by means of exchanging, between the further user's electronic device and the electronic operator device, of text messages of an online chat and/or by means of exchanging audio/audio-video messages of an audio/audio-video online chat, wherein the text and/or audio/audio-video messages are carried through said telecommunications network;
n1) analyzing, by means of the further electronic operator device, at least a part of a further digital identity reference profile of a further user of the further user's electronic device;
o1) in case of a positive analysis, approving by means of the electronic operator device the step of the further plurality and repeating l1), m1), n1), o1) for a further step of the further plurality of steps;
p1) in case of a negative analysis, repeating the execution of the step of the further plurality of steps of the further interaction process and returning to n1), till completing the execution of the further plurality of steps with positive verifications.
